(19) United States
(12) Patent Application Publication
(10) Pub. No.: US 2026/0124027 A1
(43) Pub. Date: May 7, 2026

(54) AUTOMATIC ORAL CARE DEVICE

(71) Applicants: Suneel Ismail Sheikh, Shoreview, MN (US); Chuck Satoshi Hisamoto, Woodbury, MN (US); Mark Charles Olander, Minneapolis, MN (US); Michael Jason Ward, Brooklyn Center, MN (US); Samuel Alan Smidt, Minneapolis, MN (US)

(72) Inventors: Suneel Ismail Sheikh, Shoreview, MN (US); Chuck Satoshi Hisamoto, Woodbury, MN (US); Mark Charles Olander, Minneapolis, MN (US); Michael Jason Ward, Brooklyn Center, MN (US); Samuel Alan Smidt, Minneapolis, MN (US)

(21) Appl. No.: 19/374,770

(22) Filed: Oct. 30, 2025

Related U.S. Application Data
(60) Provisional application No. 63/715,213, filed on Nov. 1, 2024.

(51) Int. Cl. A61C 17/22; A61C 17/34; A61C 19/06

(52) U.S. Cl. CPC A61C 17/221; A61C 17/228; A61C 17/3481; A61C 17/349; A61C 19/063

(57) ABSTRACT

An oral care device can include a mouthpiece configured for at least partial insertion into a mouth of a user. The mouthpiece can include an arcuate shape to cover a tooth of the user. The mouthpiece can include oral engagement members removably installed into the mouthpiece and configured to contact oral surfaces. A sensor can be integrated within the mouthpiece. The sensor can be configured to detect an operational characteristic of the mouthpiece during use by the user. A base can be configured to receive the mouthpiece and charge and clean the mouthpiece upon connection with the mouthpiece. A control system can be configured to control the operation of the oral care device based on at least one operational characteristic of the mouthpiece.

### CLAIM OF PRIORITY

This patent application claims the benefit of priority, under 35 U.S.C. Section 119(e), to Suneel Sheikh U.S. patent application Ser. No. 63/715,213, entitled “AUTOMATIC ORAL CARE DEVICE,” filed on Nov. 1, 2024 (Attorney Docket No. 5188.002PRV), which is hereby incorporated by reference herein in its entirety.

### TECHNICAL FIELD

The present disclosure relates to oral hygiene devices. More specifically, the present disclosure relates to automated dental care systems designed to assist users in maintaining effective oral health.

### BACKGROUND

Maintaining effective oral hygiene can be important for overall health and well-being. Regular oral care routines can help prevent oral diseases such as dental caries, periodontal disease, and soft tissue pathology. Poor oral hygiene can lead to pain, infection, tooth loss, and serious systemic health consequences, ultimately diminishing quality of life.

### BRIEF DESCRIPTION OF THE DRAWINGS

Various examples are illustrated in the figures of the accompanying drawings. Such examples are demonstrative and not intended to be exhaustive or exclusive examples of the present subject matter.

FIG. 1 is a perspective view of an example of an oral care device.

FIG. 2 is a schematic diagram of an example of an oral care device.

FIG. 3 is a flowchart for an example of a method for an oral care device.

FIG. 4 is a perspective view of an example of a mouthpiece.

FIG. 5 is an enlarged view of a portion of the mouthpiece from FIG. 4.

FIG. 6 is a schematic diagram of an example of a mouthpiece cleaning oral surfaces of a user.

FIG. 7 is a perspective view of an example of a mouthpiece.

FIG. 8 is a perspective view of an example of a mouthpiece.

FIG. 9 is a side view of an example of track portions of oral engagement members.

FIG. 10 is a perspective view of an example of a mouthpiece.

FIG. 11 is a block diagram illustrating an example of a machine upon which one or more examples may be implemented.

### DETAILED DESCRIPTION

The present disclosure includes an automatic oral care device that offers a comprehensive solution by providing a hands-free, easy-to-use system that can facilitate routine oral hygiene care for individuals. The device can include a mouthpiece with integrated sensors and powered bristles that automatically adjust to the user, ensuring effective cleaning while maintaining comfort and safety. The system can include a base station for charging and cleaning the mouthpiece, along with a control system that can monitor and adjust the operation of the device, such as based on real-time or other feedback. This innovative approach aims to enhance and simplify oral health outcomes, reduce caregiver burden, and improve overall quality of life for users.

The oral care device can include a mouthpiece configured for at least partial insertion into a mouth of a user. The mouthpiece can include an arcuate shape to follow a dental arch and cover a tooth and a gumline of the user. The mouthpiece can include oral engagement members that can be removably installed into the mouthpiece and configured to contact oral surfaces. A sensor can be integrated into the mouthpiece. The sensor can be configured to detect an operational characteristic of the mouthpiece during use by the user. A base can be configured to receive the mouthpiece and charge and clean the mouthpiece upon connection of the base with the mouthpiece. A control system can be configured to control the operation of the oral care device based at least in part on the operational characteristic of the mouthpiece.

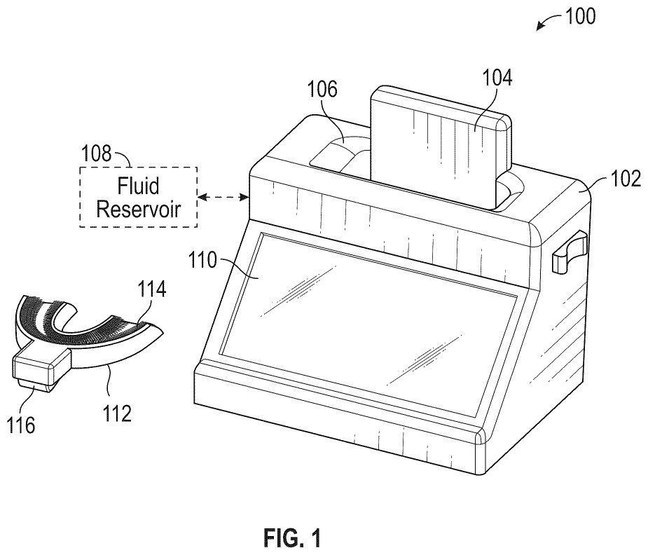

FIG. 1 is a perspective view of an example of an oral care device 100. The oral care device 100 can be used for oral hygiene routines, such as in residential or medical settings (e.g., hospitals, nursing homes, assisted living facilities, or the like). The oral care device 100 can also be portable so the oral care device 100 can be used in an office setting, traveling, camping, in hotels, or the like. The oral care device 100 can help ensure good oral hygiene for an end-user of the oral care device 100. The oral care device 100 can include a base 102 and a mouthpiece 112.

The base 102 can receive the mouthpiece 112 to charge and clean the mouthpiece 112 upon connection with the mouthpiece 112. To help charge the mouthpiece 112, the base 102 can include a charging interface 104. The charging interface 104 can convey a charge to the mouthpiece 112 via an electrical connection (e.g., electrical pads or electrically conductive connections) or a wireless connection (e.g., Qi, Power Matters Alliance (PMA), or any other wireless charging technique). The base 102 can also include a cleaning reservoir 106, a fluid reservoir 108, and a graphical user interface 110.

The cleaning reservoir 106 can include or be provided with a cleaning solution (e.g., baking soda, white vinegar, a commercially available denture, retainer, or removable cleaner, or the like). The cleaning reservoir 106 can also include an ultrasonic cleaning source to clean the mouthpiece 112 using ultrasonic energy. The cleaning reservoir 106 can completely receive the mouthpiece 112 therein or can receive a portion of the mouthpiece 112 therein to clean the mouthpiece 112 between uses. The cleaning reservoir 106 can be configured to remove plaque, any leftover cleaning solution, bacteria, or the like from the mouthpiece 112 after each use by the user. In examples, the base 102 can charge the mouthpiece 112 while the mouthpiece 112 is at least partially inserted into the cleaning reservoir 106 for cleaning.

The mouthpiece 112 can be inserted into the mouth of the end user. The mouthpiece 112 can include an arcuate shape to easily fit within the mouth. As such, different sizes of the mouthpiece 112 can be included to fit end users of different mouth sizes. For example, there can be multiple sizes of the mouthpiece 112 that come with the oral care device 100 such that multiple users within a household can use the oral care device 100 for their oral hygiene routine. The mouthpiece 112 can include a rigid structure such as to help prevent bending or deformation of the mouthpiece 112 during the use of the oral care device 100. The mouthpiece 112 can also include a flexible structure to ensure easy maneuvering of the mouthpiece 112 within the mouth of the user. The mouthpiece 112 can include oral engagement members 114, and a fluid tank 116.

The oral engagement members 114 can be permanently installed within the mouthpiece 112 and the oral engagement members 114 and the mouthpiece 112 can be configured to be discarded after a single use. In such examples, the mouthpiece 112 and the oral engagement members 114 can include lower-cost materials that only have to withstand a single (or a few) uses of the mouthpiece 112 and the oral engagement members 114. The oral engagement members 114 can be permanently installed within the mouthpiece 112, such that the mouthpiece 112 and the oral engagement members 114 are not replaceable and the oral engagement members 114 and the mouthpiece 112 can be discarded after either of the mouthpiece 112 or the oral engagement members 114 become worn. Alternatively, the oral engagement members 114 can be removably coupled to the mouthpiece 112 such that the oral engagement members 114 can be a single-use, or limited-use product, and the mouthpiece 112 can be a multi-use, or more permanent-use, product. In other words, the oral engagement members 114 typically wear out faster than the mouthpiece 112, so the oral engagement members 114 can be removably coupled to the mouthpiece 112. With the oral engagement members 114 removably coupled to the mouthpiece 112 the oral engagement members 114 can be replaced many times before the oral engagement members 114 is worn out and needs to be discarded. The oral engagement members 114 can contact the oral surfaces (e.g., one or more facial, occlusal, proximal, incisal, or lingual surfaces of the teeth, gums, or tongue) of the end user. The mouthpiece 112 can include one or more energy devices to transmit energy (e.g., vibrational, ultrasonic or other acoustic, or the like) to the oral engagement members 114.

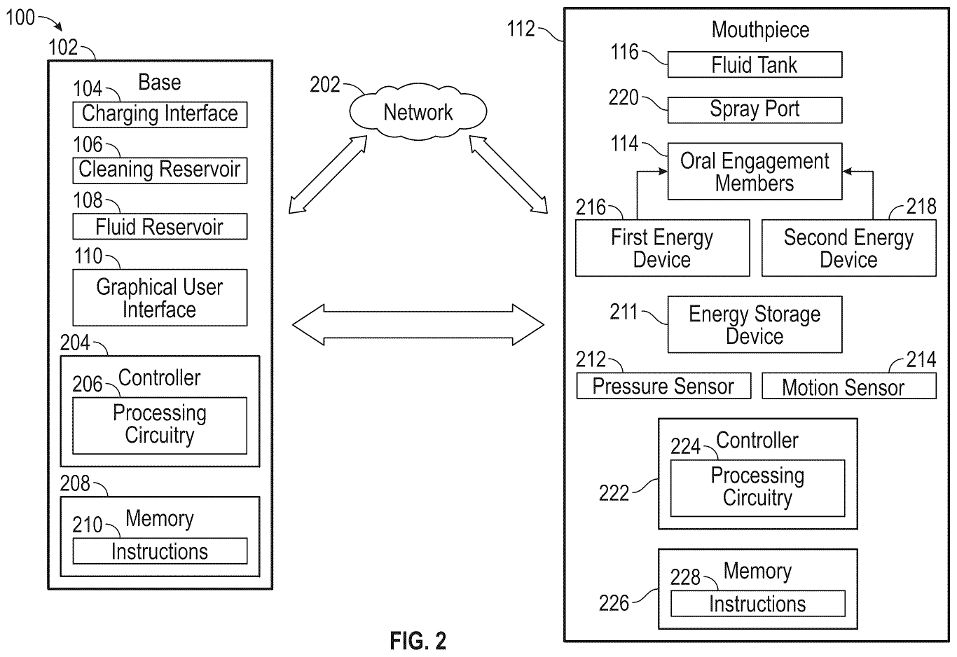

The fluid tank 116 can be configured to hold, store, and distribute an oral cleaning solution onboard the mouthpiece 112. A volume of the fluid tank 116 can be adjusted based on the size of the mouthpiece 112. For example, the fluid tank 116 can include a smaller volume to be sized to store a single-use amount of the oral cleaning solution. In another example, the fluid tank 116 can include a larger volume to be sized for multiple uses of the mouthpiece 112. The fluid tank 116 can include a flexible material (e.g., a plastic, polymer, or the like), which can deform upon engagement of the fluid tank 116 by a user, or caretaker of the user of the mouthpiece 112. The oral care device 100 will be discussed in more detail herein with reference to FIG. 2-FIG. 11.

FIG. 2 is a schematic diagram of an example of an oral care device 100. The oral care device 100 can be configured to automate oral hygiene routines such as for use in residential, health care, assisted living, or other living environments.

The base 102 can include a controller 204, including processing circuitry 206, which can be coupled to a memory 208, including instructions 210. The controller 204 can monitor the systems of the base 102 and transmit information to the graphical user interface 110 based on the status of the components of the base 102. For example, if there is an error with the charging interface 104, the charging interface 104 is connected to the mouthpiece 112, the controller 204 can transmit the error detected or the status of charging from the charging interface 104 to the graphical user interface 110.

The controller 204 can also monitor the cleaning reservoir 106. For example, the controller 204 can detect a level of debris or matter contained within the cleaning reservoir 106, a cleanliness of the cleaning solution, a level of the cleaning solution, or the like, and transmit the conditions of the cleaning reservoir 106 to the graphical user interface 110 to notify the user of the oral care device 100.

The controller 204 can also provide information regarding the fluid reservoir 108. For example, the controller 222 can determine type of fluid installed within the fluid reservoir 108, the amount of fluid within the fluid reservoir 108, or detect the fluid within the fluid reservoir 108 requires servicing and display the information regarding the fluid reservoir 108 via the graphical user interface 110.

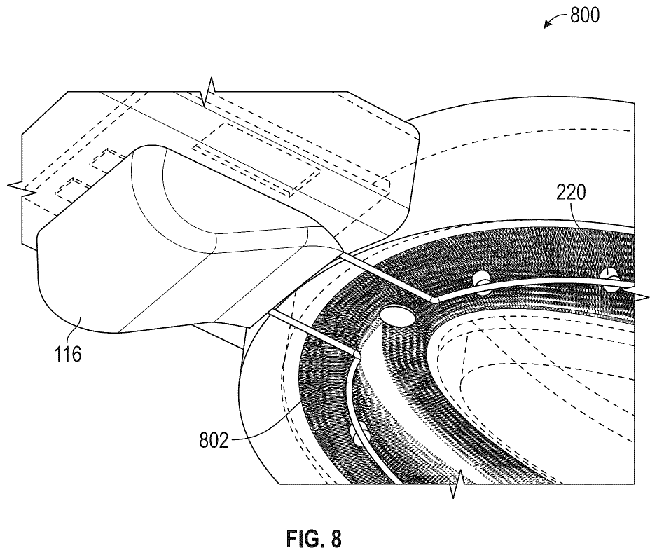

The mouthpiece 112 can include a fluid tank 116 designed to store oral cleaning solutions (e.g., at least one of toothpaste, mouthwash, water, or a medicated solution). A spray port 220 can facilitate the distribution of the oral cleaning solutions from the fluid tank 116 onto the oral surfaces (e.g., one or more facial, occlusal, proximal, incisal, or lingual surfaces of the teeth, gums, or tongue). The fluid tank 116 and the spray port 220 can help the oral care device 100 reduce the amount of oral cleaning solution required for cleaning the oral surfaces than traditional cleaning methods (e.g., electric or manual toothbrushes). The fluid tank 116 and the spray port 220 will be discussed in more detail herein with reference to FIG. 8.

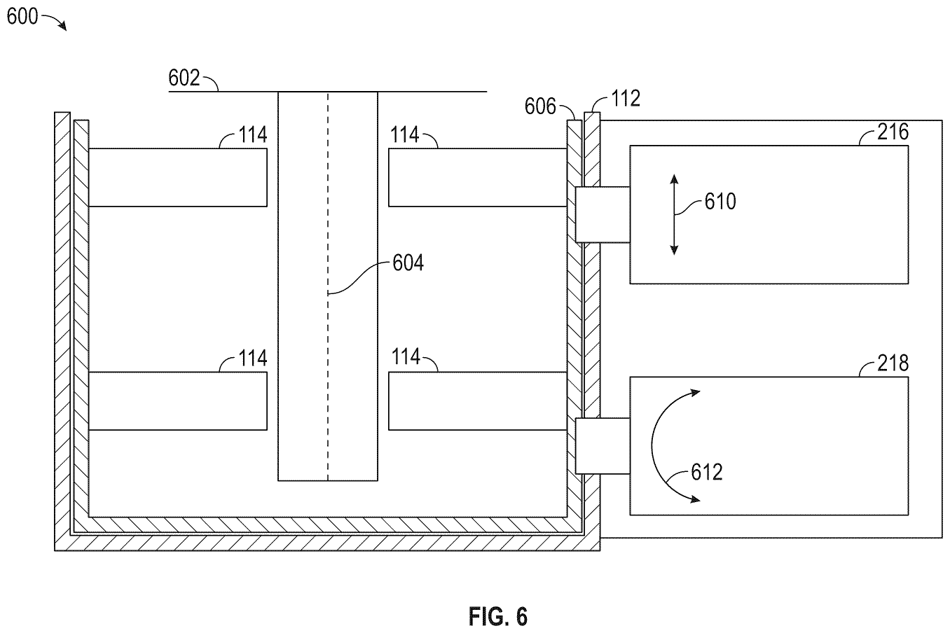

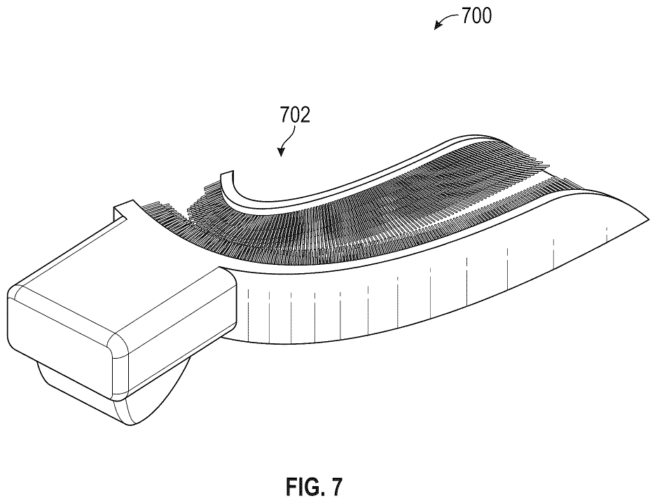

The oral engagement members 114 can be configured to contact the oral surfaces to ensure effective cleaning for the end user. The mouthpiece 112 can also house a first energy device 216 and a second energy device 218, which can provide vibrational and translational energy to the oral engagement members 114, enhancing the cleaning process. The first energy device 216 can translate the oral engagement members 114 along a first axis. The first axis can align with a long axis of the teeth of the user. The second energy device 218 can generate a vibrational frequency and propagate the vibrational frequency to the oral engagement members 114. The vibrational frequency provided to the oral engagement members 114 by the second energy device 218 can stimulate the oral surfaces to clean the mouth of the end user. For more discussion on the first energy device 216 and the second energy device 218, see FIG. 6.

The mouthpiece 112 can include an energy storage device 211 (e.g., a battery). The energy storage device 211 can include lithium-ion, nickel-metal hydride, alkaline, lithium polymer, button cell batteries, nickel-cadmium, zinc-carbon, lithium iron phosphate batters, or the like. The energy storage device 211 can be replaceable or rechargeable. The energy storage device 211 can store energy provided by the base 102 and convey the stored energy to one or more components of the mouthpiece 112 to run or operate the mouthpiece 112 without wires connecting the mouthpiece 112 to the base 102. The energy storage device 211 can be charged via the charging interface 104 of the base 102.

The mouthpiece 112 can include one or more sensors (e.g., a pressure sensor 212 or a motion sensor 214). In some examples, the pressure sensor 212 can detect the pressure applied to the oral surfaces from the oral engagement members 114. In some examples, the pressure sensor 212 can detect the pressure applied to the oral engagement members 114 from the oral surfaces of the patient. For example, if the patient clenches their jaw, the pressure sensor 212 can detect an increase in pressure, and if the patient opens their jaw, the pressure sensor 212 can detect a decrease in pressure.

The motion sensor 214 can be configured to detect an orientation of the mouthpiece 112. For example, the motion sensor 214 can detect whether the mouthpiece 112 is inserted within the mouth of the patient, whether the mouthpiece 112 is properly installed on the oral surfaces of the patient, the position or orientation of the patient using the oral care device 100 (e.g., whether the patient is laying down or sitting up), or whether the patient moves during operation of the oral care device 100. The motion sensor 214 can include an accelerometer to generate a movement signal indicative of sudden movement of the oral engagement members 114. The motion sensor 214 can also determine a position of the oral care device 100 relative to the patient. For example, the motion sensor 214 can determine when the oral care device 100 is inserted correctly and is covering a tooth and gumline of the patient. In other words, the motion sensor 214 can include multiple sensors (e.g., an accelerometer, a gyroscope sensor, a proximity sensor to detect dental surfaces or gum tissue, magnetometer, or the like) to detect an orientation of the mouthpiece 112 or the end user while the mouthpiece 112 is installed in the mouth of the user, detect movements of the mouthpiece 112 or the patient before or during use of the mouthpiece 112, or a position of the mouthpiece 112 within the mouth of the user to ensure proper installation of the mouthpiece 112 before or during operation of the mouthpiece 112.

The pressure sensor 212 and the motion sensor 214 can be in communication with the processing circuitry 224 of the controller 222 to transmit pressure signals and position signals, respectively, to the controller 222. The controller 222 and the processing circuitry 224 can be coupled to a memory 226 including instructions 228. The data collected by these sensors can be processed by a controller 222, which can include processing circuitry 224, memory 226, and instructions 228, enabling real-time adjustments to the device's operation based on user feedback.

For example, the instructions 228 can configure the processing circuitry 224 of the controller 222 to monitor the movement signal (e.g., from the motion sensor 214) and determine a magnitude of movement of the mouthpiece 112. The controller 222 can determine the magnitude of movement of the mouthpiece 112 is beyond a movement threshold and transmit a stop operation signal to the mouthpiece 112 to inhibit or prevent the operation of the mouthpiece. For example, the stop operation signal can turn off any one or more of the oral engagement members 114, the first energy device 216, or the second energy device 218.

The controller 222 can determine the magnitude of movement is within the orientation threshold range and transmit a start operation signal to the mouthpiece 112 to start brushing operations. For example, the controller 222 can transmit a signal to either the first energy device 216 or the second energy device 218 to begin the cleaning operations of the oral care device 100.

The controller 222 can receive signal (e.g., from the motion sensor 214) and determine a calculated orientation of the mouthpiece 112. Then, based on the calculated orientation of the mouthpiece 112 being beyond an orientation threshold, the controller 222 can then transmit a stop operation signal to the mouthpiece 112 to inhibit or prevent operation of the mouthpiece 112. For example, the controller 222 determine the oral engagement members 114 is not properly inserted into the mouth of the user and can turn off or prevent power from being supplied to one or more of the first energy device 216 or the second energy device 218.

The controller 222 can determine the calculated orientation is within the orientation threshold range and transmit a start operation signal to the mouthpiece 112 to start brushing operations upon proper insertion of the mouthpiece 112 onto the oral surfaces and specified positioning of the user. For example, the controller 222 can detect the mouthpiece 112 is properly inserted into a mouth of the end user and can start cleaning operations by sending signals to at least one of the first energy device 216 or the second energy device 218.

The controller 222 can receive the pressure signal (e.g., from the pressure sensor 212) and determine a calculated pressure. The calculated pressure can be a pressure exerted on the oral surfaces by the oral engagement members 114 of the mouthpiece or a pressure exerted on the oral engagement members 114 by the oral surfaces of the user. Based on the exerted pressure being within a pressure threshold range, the controller 222 can transmit a start operation signal to provide power to one or more of the first energy device 216 or the second energy device 218.

The controller 222 can also determine that the calculated pressure is outside the pressure threshold range and transmit a stop operation signal to the mouthpiece 112 to inhibit or prevent the operation of the mouthpiece 112. For example, the controller 222 can determine that either the oral engagement members 114 are applying too much pressure to the oral surfaces of the user, which likely indicates the mouthpiece 112 is not properly installed on the patient, or the patient exerted pressure beyond a threshold on the oral engagement members 114, which can indicate discomfort, pain, or incorrect installation of the mouthpiece 112 within the mouth of the user.

The system can be connected to a network 202, allowing for remote monitoring and control. As such, the controller 204 and the controller 222 can communicate with the controller 204 to display errors detected by the controller 222 on the graphical user interface 110. For example, if the energy storage device 211 is low on stored energy, the controller 222 can transmit an alert to the controller 204 for display on the graphical user interface 110. The controller 204 and the controller 222 can also communicate to track and log operational information such as the run time of the oral care device 100, the pressures detected during operation of the oral care device 100, the position or orientation of the mouthpiece 112 during the operation of the oral care device 100, or the like. This logged information can be used to help predict preventative maintenance schedules or predict the failure of components before they reach their failure point.

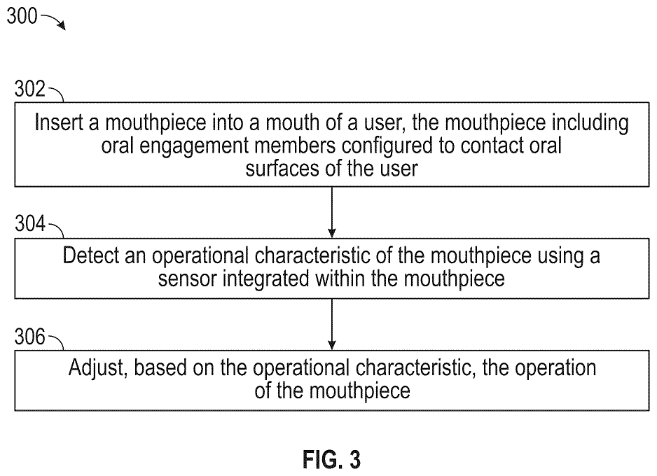

FIG. 3 is a flowchart for an example of portions of a method 300 for an oral care device (e.g., the oral care device 100, FIG. 1). The method 300 can be an example of a method for the use of the oral care device 100 (FIG. 1). The method 300 can optionally include any one or more of operations 302-306.

At operation 302, the method 300 can include inserting the mouthpiece (e.g., the mouthpiece 112, FIG. 1) into the mouth of a user. The mouthpiece 112, as described in FIG. 2, can include oral engagement members (e.g., the oral engagement members 114, FIG. 1) configured to contact the oral surfaces. The mouthpiece 112 and the oral engagement members 114 can ensure proper positioning for effective cleaning.

At operation 304, the method 300 can include detecting an operational characteristic (e.g., an orientation, a pressure, movement, or the like) of the mouthpiece using integrated sensors (e.g., the motion sensor 214, the pressure sensor 212, or the like). These sensors, such as the pressure sensor 212 and motion sensor 214, can be configured to monitor parameters like pressure and orientation of the mouthpiece 112, providing real-time feedback on the between the mouthpiece and the oral surfaces of the user.

At operation 306, the method 300 can include adjusting the operation of the mouthpiece (e.g., starting brushing, stopping brushing, changing a speed of brushing, or the like) based on the data received from the sensors. The control system, including the controller 222 (FIG. 2) with processing circuitry 224 (FIG. 2), can make real-time adjustments to optimize cleaning performance while ensuring user comfort and safety.

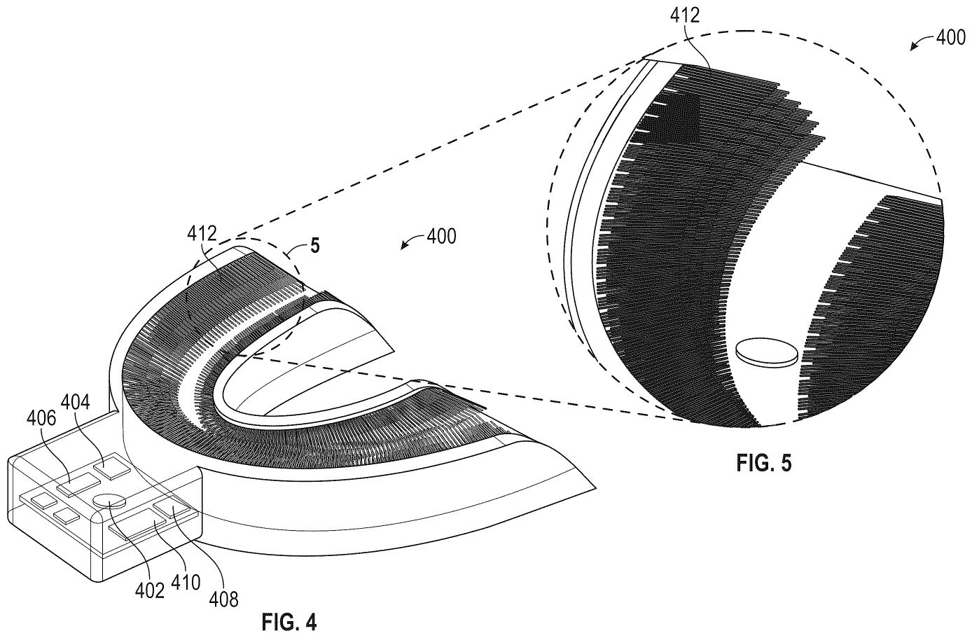

FIG. 4 is a perspective view of an example of a mouthpiece 400 (e.g., the mouthpiece 112, FIG. 1). The mouthpiece 400 can include a switch 402, a first energy device 404, a sensor 408, a second energy device 406, an energy source 410, and oral engagement members 412 (e.g., oral engagement members 114, FIG. 1). The switch 402 can be the primary control mechanism for activating the mouthpiece 400. The switch 402 can allow the user to initiate or terminate the operation of the mouthpiece 400 as needed. The switch 402 can include a pushbutton switch, slide switch, toggle switch, rotary switch, or the like. In some examples, the switch 402 can be engaged to change an operation mode (e.g., such as constant operation, pulse operation, timed operation, or the like).

The first energy device 404 (e.g., the first energy device 216, FIG. 2) can include a motor, actuator, other translation rotation, or vibration generating means, or the like to provide power to the mouthpiece 400 and facilitate the movement of oral engagement members 412. The first energy device 404 can be configured to translate the oral engagement members 412 along an axis, which can align with a long axis of the teeth of the user. The first energy device 404 can be configured to vibrate, rotate, or translate the oral engagement members 412 to improve the cleaning of the oral surfaces.

The second energy device 406 (e.g., the second energy device 218, FIG. 2) can include a motor, actuator, other translation rotation, or vibration generating means, or the like to provide power to the mouthpiece 400 and facilitate the movement of oral engagement members 412. The energy generated by the second energy device 406 can aid in loosening plaque and debris from the oral surfaces, contributing to a thorough cleaning experience. In some examples, the first energy device 404 and the second energy device 406 can be configured to provide energies in different modes (e.g., translation, vibration, or rotation) or different frequencies such as to help increase the cleaning effect of the oral engagement members 412.

The sensor 408 (e.g., the pressure sensor 212 or the motion sensor 214 FIG. 2) can monitor the mouthpiece 400 and transmit a signal indicative of one or more characteristics of the mouthpiece 400. The sensor 408 can transmit the signal to a control unit (e.g., the controller 222, FIG. 2) of the mouthpiece 400 so that the control unit can ensure that the mouthpiece 400 maintains the correct alignment or orientation within the mouth of the patient during operation to optimize the effectiveness of the cleaning action.

The energy source 410 (e.g., the energy storage device 211, FIG. 2) can include one or more batteries to provide power to one or more components (e.g., the first energy device 404, the second energy device 406, or any other component of the mouthpiece 400). The energy source 410 can be designed to be compact and efficient, providing the necessary power without adding significant bulk to the mouthpiece 400. As discussed herein, the energy source 410 can be configured to receive a charge via the charging interface 104 (FIG. 1) of the base 102 (FIG. 1).

FIG. 5 is an enlarged view of a portion of the mouthpiece 400 from FIG. 4. As discussed above, the mouthpiece 400 can include the oral engagement members 412. The oral engagement members 412 can include a series of bristles designed to engage with the oral surfaces (e.g., one or more facial, occlusal, proximal, incisal, or lingual surfaces of the teeth, gums, or tongue) to facilitate effective cleaning. The bristles of the oral engagement members 412 can be arranged in a manner that allows them to cover multiple surfaces simultaneously, ensuring comprehensive cleaning of the dental surfaces. The bristles of the oral engagement members 412 can include fibrous materials, polymers, plastics, composites, impregnated materials, any combination thereof, or the like.

The shape, distribution, arrangement, or the like of the oral engagement members 412 can be configured to conform to the natural contours of the oral cavity, providing a snug fit that enhances cleaning efficiency. The bristles of the oral engagement members 412 can be positioned at various angles to optimize contact with different areas of the mouth, including hard-to-reach regions.

The stiffness of the oral engagement members 412 can be adjustable or varied to accommodate different user preferences and sensitivities. This variability in stiffness can allow the device to provide a gentle yet effective cleaning action, minimizing discomfort while maximizing plaque removal and debris dislodgement. In examples, the oral engagement members 412 can vary in stiffnesses at different portions of the mouthpiece 400. For example, the oral engagement members 412 configured to engage the oral surfaces around the molars can include a stiffness that is greater than a stiffness of the oral engagement members 412 configured to engage the oral surfaces around the centrals or the laterals. In some examples, the oral engagement members 412 configured to engage the oral surfaces around the molars can include a stiffness that is less than a stiffness of the oral engagement members 412 configured to engage the oral surfaces around the centrals or laterals. In some examples, the oral engagement members 412 can be removable and replaceable, allowing for easy maintenance of the mouthpiece 400. The removable and replaceable nature of the oral engagement members 412 can help maintain the efficiency of the mouthpiece 400 for many uses.

FIG. 6 is a schematic diagram of an example of a mouthpiece 600 cleaning oral surfaces 602 of a user. As shown in FIG. 6, the oral surfaces 602 can include a tall axis 604 aligned of a tooth. As shown in FIG. 6, the mouthpiece 112 can include a tray 606. The tray 606 can be connected to the first energy device 216 and the second energy device 218 and can be configured to receive each of the oral engagement members 114.

As shown in FIG. 6, the first energy device 216 can be configured to translate the oral engagement members 114 via the tray 606 in the first direction 610. The first direction 610 can be substantially aligned with, or parallel to, the tall axis 604. The second energy device 218 can be configured to generate a rotational energy to the oral engagement members 114 via the tray 606 in the second direction 612. The second direction 612 can also illustrate a vibrational energy generated by the second energy device 218. In examples, the first energy device 216 and the second energy device 218 can both be configured to provide energy to translate or vibrate the oral engagement members 114 in the first direction 610 or the second direction 612.

In some examples, the mouthpiece 600 can offer a range of customizable features to enhance user experience and effectiveness. Users can select from interchangeable examples of the oral engagement members 114, allowing the user to choose different bristle types or configurations based on personal preference or specific oral care needs. The mouthpiece 700 can also provide adjustable settings for cleaning intensity, enabling users to tailor the vibrational and translational energies to their comfort level. The customization of the mouthpiece 700 can ensure that the mouthpiece 700 can accommodate various oral conditions and sensitivities, providing a personalized and effective cleaning experience for each user.

FIG. 7 is a perspective view of an example of a mouthpiece 700 (e.g., the mouthpiece 112, FIG. 1, the mouthpiece 400, FIG. 4). The mouthpiece 700 can include a j-shaped profile or a semi-arcuate profile 702, which can contribute to an ergonomic design and functionality of the mouthpiece 700.

The semi-arcuate profile 702 can provide the mouthpiece 700 with a shape that aids in fitting comfortably within the mouth. More specifically, the semi-arcuate profile 702 can make it easier to insert or remove the mouthpiece 700 into and from the mouth of a user. Moreover, the semi-arcuate profile 702 limits the total area of contact between the mouthpiece 700 and the oral surfaces of the patient. Reducing the area of contact between the mouthpiece 700 and the oral surfaces of the patient can reduce the overall oral stimulation, which can make the cleaning process more comfortable for users with teeth sensitivities. In examples, mouthpiece 700 include the semi-arcuate profile 702 can be configured to clean the upper and lower teeth of the same side of the mouth of the user simultaneously.

The semi-arcuate profile 702 can also ensure the mouthpiece 700 can be better positioned within the mouth to ensure adequate cleaning of all oral surfaces when compared to u-shaped versions of a mouthpiece. As the semi-arcuate profile 702 only covers a portion of the oral surfaces, there is more flexibility in adjusting the position of the mouthpiece 700 relative to the oral surfaces. The mouthpiece 700 can be configured to be used in four cycles to clean the oral surfaces of a user. For example, the mouthpiece 700 can be installed on any of the upper right, upper left, lower right, or lower left oral surfaces of the patient for each cycle of operation.

FIG. 8 is a perspective view of an example of a mouthpiece 800 (e.g., the mouthpiece 112, FIG. 1, the mouthpiece 400, FIG. 4, the mouthpiece 700, FIG. 7, or the like). As discussed herein, the mouthpiece 800 can include the fluid tank 116 and the spray port 220 to distribute a cleaning solution to the oral surfaces around the mouthpiece 800. As shown in FIG. 8, mouthpiece 800 can include channel 802 to distribute the cleaning solution from the fluid tank 116 to one or more spray ports 220.

As the spray port 220 directs the oral cleaning solutions directly to the oral surface, less oral cleaning solution can be used than other oral cleaning methods. The decrease in the oral cleaning solution required to effectively clean the oral surfaces can provide a cleaner, mess-free solution to dental hygiene. As a result, the mouthpiece 800 can be used away from a sink, as the user does not need to spit out or flush out the oral cleaning solution after using the mouthpiece 800.

The channel 802 can extend between the fluid tank 116 to each spray port 220. The channel 802 connecting the fluid tank 116 to the spray port 220 enables the spray port 220 to be distributed about the mouthpiece 800 to provide even coverage of the oral cleaning solution on the oral surfaces of the user. The even coverage can help ensure consistent cleaning of the oral surfaces.

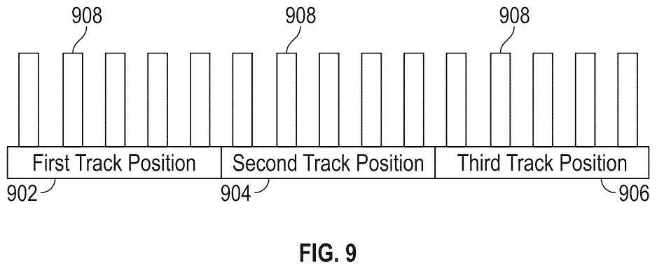

FIG. 9 is a side view of an example mouthpiece 900 (e.g., mouthpiece 112, FIG. 1, mouthpiece 400, FIG. 4, mouthpiece 700, FIG. 7, or mouthpiece 800, FIG. 8) including track portions 902, 904, and 906. Each of the track portions 902, 904, and 906 can include a plurality of groupings of oral engagement members 908. The track portions 902, 904, and 906 can be distributed throughout the mouthpiece 900 so that each of the plurality of groupings of oral engagement members 908 contacts the oral surfaces of the user.

The first track portion 902, second track portion 904, and third track portion 906 can each support multiple groupings of oral engagement members 908. Each grouping of oral engagement members 908 can include bristles. The bristles of each grouping of the plurality of groupings of oral engagement members 908 can include a stiffness. The stiffness of the bristles can vary between each group of the plurality of groupings of oral engagement members 908. In some examples, each of the track portions 902, 904, and 906 can include bristles of equal stiffness. In some examples, the bristles in each of the track portions 902, 904, and 906 can have different stiffnesses. In some examples, the bristles of each grouping of the plurality of groupings of the oral engagement members 908 can include different stiffnesses on the same or on different track portions 902, 904, and 906.

The track portions 902, 904, and 906 can facilitate easy attachment and removal of the oral engagement members 908, allowing for customization and maintenance of the mouthpiece 900. This flexibility can ensure that the mouthpiece 900 remains effective and user-friendly, catering to the diverse needs of individuals seeking improved oral hygiene.

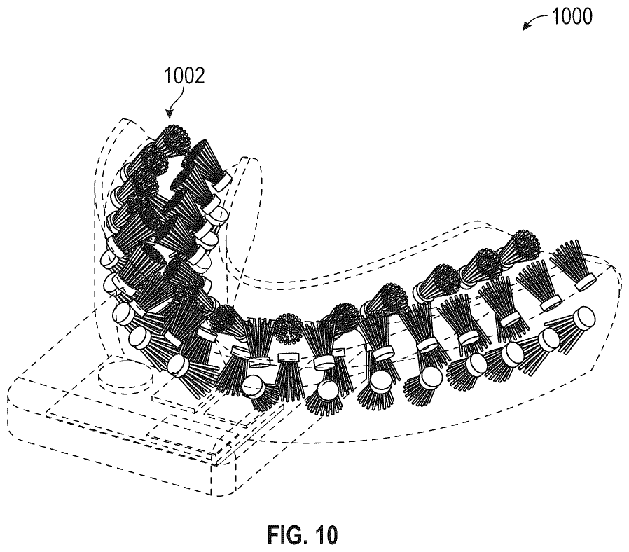

FIG. 10 is a perspective view of an example of a mouthpiece 1000 (e.g., mouthpiece 112, FIG. 1, mouthpiece 400, FIG. 4, mouthpiece 700, FIG. 7, mouthpiece 800, FIG. 8, or mouthpiece 900, FIG. 9). As shown in FIG. 10, the mouthpiece 1000 can include a plurality of groupings of oral engagement members 1002. Each grouping of oral engagement members of the plurality of groupings of oral engagement members 1002 can include bristles configured to engage the oral surfaces of a user. In some examples, the plurality of groupings of oral engagement members 1002 can be installed on a tray such that the engagement members of the plurality of groupings of oral engagement members 1002 can be inserted or removed from the mouthpiece 1000 simultaneously. In some examples, each grouping of the plurality of groupings of oral engagement members 1002 can be removed or replaced individually to permit low-cost maintenance of the mouthpiece 1000.

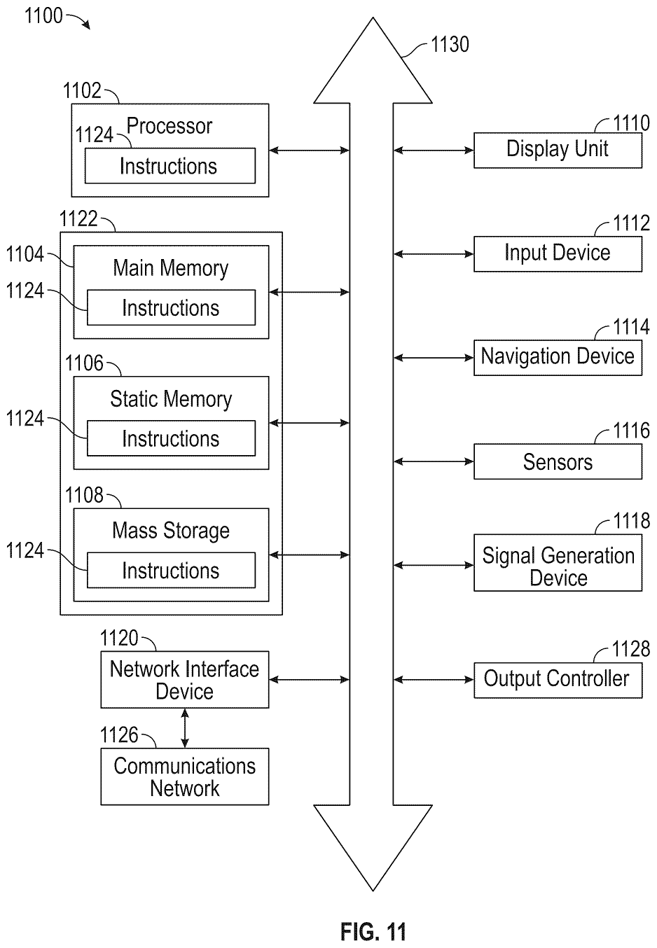

FIG. 11 is a block diagram of an example machine 1100 upon which any one or more of the techniques (e.g., methodologies) discussed herein may perform. Examples, as described herein, may include, or may operate by, logic or a number of components, or mechanisms in the machine 1100. Circuitry (e.g., processing circuitry) is a collection of circuits implemented in tangible entities of the machine 1100 that include hardware (e.g., simple circuits, gates, logic, etc.). Circuitry membership may be flexible over time. Circuitries include members that may, alone or in combination, perform specified operations when operating. In some examples, hardware of the circuitry may be immutably designed to carry out a specific operation (e.g., hardwired). In an example, the hardware of the circuitry may include variably connected physical components (e.g., execution units, transistors, simple circuits, etc.), including a machine-readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, in an example, the machine-readable medium elements are part of the circuitry or are communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time. Additional examples of these components with respect to the machine 1100 follow.

In alternative examples, the machine 1100 may operate as a standalone device or may be connected (e.g., networked) to other machines. In a networked deployment, the machine 1100 may operate in the capacity of a server machine, a client machine, or both in server-client network environments. In an example, the machine 1100 may function as a peer machine in a peer-to-peer (P2P) (or other distributed) network environment. The machine 1100 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

The machine 1100 may include a hardware processor 1102 (e.g., a central processing unit (CPU), a graphics processing unit (GPU), a hardware processor core, or any combination thereof), a main memory 1104, a static memory (e.g., memory or storage for firmware, microcode, a basic-input-output (BIOS), and mass storage 1108 (e.g., hard drives, tape drives, flash storage, or other block devices) some or all of which may communicate with each other via an interlink 1130 (e.g., bus). The machine 1100 may further include a display unit 1110, an alphanumeric input device 1112 (e.g., a keyboard), and a user interface (UI) navigation device 1114 (e.g., a mouse). In examples, the display unit 1110, input device 1112 and UI navigation device 1114 may be a touch screen display. The machine 1100 may additionally include a signal generation device 1118 (e.g., a speaker), a network interface device 1120, and one or more sensors 1116, such as a global positioning system (GPS) sensor, compass, accelerometer, or other sensors. The machine 1100 may include an output controller 1128, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

Registers of the processor 1102, the main memory 1104, the static memory 1106, or the mass storage 1108 may be, or include, a machine-readable medium 1122 on which is stored one or more sets of data structures or instructions 1124 (e.g., software) embodying or utilized by any one or more of the techniques or functions described herein. The instructions 1124 may also reside, completely or at least partially, within any of the registers of the processor 1102, the main memory 1104, the static memory 1106, or the mass storage 1108 during execution thereof by the machine 1100. In some examples, one or any combination of the hardware processor 1102, the main memory 1104, the static memory 1106, or the mass storage 1108 may constitute the machine-readable media 1122. While the machine-readable medium 1122 is illustrated as a single medium, the term “machine-readable medium” may include a single medium or multiple media (e.g., a centralized or distributed database, and/or associated caches and servers) configured to store the one or more instructions 1124.

The term “machine-readable medium” may include any medium that is capable of storing, encoding, or carrying instructions for execution by the machine 1100 and that cause the machine 1100 to perform any one or more of the techniques of the present disclosure, or that is capable of storing, encoding or carrying data structures used by or associated with such instructions. Non-limiting machine-readable medium examples may include solid-state memories, optical media, magnetic media, and signals (e.g., radio frequency signals, other photon-based signals, sound signals, etc.). In an example, a non-transitory machine-readable medium comprises a machine-readable medium with a plurality of particles having invariant (e.g., rest) mass and, thus, are compositions of matter. Accordingly, non-transitory machine-readable media are machine-readable media that do not include transitory propagating signals. Specific examples of non-transitory machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

In some examples, information stored or otherwise provided on the machine-readable medium 1122 may be representative of the instructions 1124, such as instructions 1124 themselves or a format from which the instructions 1124 may be derived. This format from which the instructions 1124 may be derived may include source code, encoded instructions (e.g., in compressed or encrypted form), packaged instructions (e.g., split into multiple packages), or the like. The information representative of the instructions 1124 in the machine-readable medium 1122 may be processed by processing circuitry into the instructions to implement any of the operations discussed herein. For example, deriving the instructions 1124 from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions 1124.

In some examples, the derivation of the instructions 1124 may include assembly, compilation, or interpretation of the information (e.g., by the processing circuitry) to create the instructions 1124 from some intermediate or preprocessed format provided by the machine-readable medium 1122. The information, when provided in multiple parts, may be combined, unpacked, and modified to create the instructions 1124. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable etc.) at a local machine, and executed by the local machine.

The instructions 1124 may be further transmitted or received over a communications network 1126 using a transmission medium via the network interface device 1120 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), LoRa/LoRaWAN, or satellite communication networks, mobile telephone networks (e.g., cellular networks such as those complying with 3G, 4G LTE/LTE-A, or 5G standards), Plain Old Telephone (POTS) networks, and wireless data networks (e.g., Institute of Electrical and Electronics Engineers (IEEE) 902.11 family of standards known as Wi-Fi®, IEEE 902.15.4 family of standards, peer-to-peer (P2P) networks, among others. In an example, the network interface device 1120 may include one or more physical jacks (e.g., Ethernet, coaxial, or phone jacks) or one or more antennas to connect to the communications network 1126. In an example, the network interface device 1120 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 1100, and includes digital or analog communications signals or other intangible medium to facilitate communication of such software. A transmission medium is a machine-readable medium.

The following, non-limiting examples, detail certain aspects of the present subject matter to solve the challenges and provide the benefits discussed herein, among others.

Example 1 is an oral care device comprising: a mouthpiece configured for at least partial insertion into a mouth of a user, the mouthpiece having an arcuate shape to cover a tooth of the user, the mouthpiece including: oral engagement members removably installed into the mouthpiece and configured to contact oral surfaces; and a sensor integrated within the mouthpiece, the sensor configured to detect an operational characteristic of the mouthpiece during use by the user; a base configured to receive the mouthpiece and charge and clean the mouthpiece upon connection with the mouthpiece; and a control system configured to control operation of the oral care device based on at least the operational characteristic of the mouthpiece.

In Example 2, the subject matter of Example 1 optionally includes wherein the mouthpiece comprises: a first energy device configured to translate the oral engagement members along a first axis; and a second energy device configured to generate a vibrational frequency and propagate the vibrational frequency to the oral engagement members.

In Example 3, the subject matter of Example 2 optionally includes wherein the first axis is configured to align with a long axis of the teeth of the user.

In Example 4, the subject matter of any one or more of Examples 2-3 optionally include wherein the oral surfaces include one or more of a facial, occlusal, proximal, incisal, or lingual surfaces of the teeth, gums, or a tongue of the patient.

In Example 5, the subject matter of Example 4 optionally includes wherein the vibrational frequency is configured to stimulate the oral surfaces to clean the oral surfaces.

In Example 6, the subject matter of any one or more of Examples 1-5 optionally include wherein the mouthpiece comprises: a fluid tank configured to store a fluid within the mouthpiece; and a spray port configured to direct the fluid toward the oral surfaces of the user.

In Example 7, the subject matter of Example 6 optionally includes wherein the fluid comprises at least one of a toothpaste, a mouthwash, or a medicated solution.

In Example 8, the subject matter of Example 7 optionally includes wherein the base comprises a reservoir to store fluid, and wherein the base is configured to refill the fluid tank of the mouthpiece when the mouthpiece is installed on the base.

In Example 9, the subject matter of any one or more of Examples 1-8 optionally include wherein the sensor includes an accelerometer, and wherein the accelerometer is configured to generate a movement signal indicative of sudden movement of the mouthpiece.

In Example 10, the subject matter of Example 9 optionally includes wherein the control system comprises: a controller including processing circuitry; and memory coupled to the controller, the memory including instructions that, when performed by the processing circuitry, are configured to cause the controller to: determine, based on the movement signal, a magnitude of movement of the mouthpiece; transmit, based on the magnitude of movement of the mouthpiece being beyond a movement threshold range, a stop operation signal to the mouthpiece to inhibit or prevent operation of the mouthpiece; and transmit, based on the magnitude of movement being within the movement threshold range, a start operation signal to the mouthpiece to start brushing operations.

In Example 11, the subject matter of any one or more of Examples 1-10 optionally include wherein the sensor includes a position sensor, and wherein the position sensor is configured to generate a position signal indicative of an orientation of the mouthpiece.

In Example 12, the subject matter of Example 11 optionally includes wherein the control system comprises: a controller including processing circuitry; and memory coupled to the controller, the memory including instructions that, when performed by the processing circuitry, are configured to cause the controller to: determine, based on the position signal, a calculated orientation of the mouthpiece; transmit, based on the calculated orientation of the mouthpiece being beyond an orientation threshold range, a stop operation signal to the mouthpiece to inhibit or prevent operation of the mouthpiece; and transmit, based on the calculated orientation being within the orientation threshold range, a start operation signal to the mouthpiece to start brushing operations upon proper insertion of the mouthpiece onto the oral surfaces and specified positioning of the user.

In Example 13, the subject matter of any one or more of Examples 1-12 optionally include wherein the sensor includes a pressure sensor, and wherein the pressure sensor is configured to generate a pressure signal indicative of a pressure exerted on the oral engagement members or the mouthpiece by the oral surfaces.

In Example 14, the subject matter of Example 13 optionally includes wherein the control system comprises: a controller including processing circuitry; and memory coupled to the controller, the memory including instructions that, when performed by the processing circuitry, are configured to cause the controller to: determine, based on the pressure signal, a calculated pressure exerted on the oral surfaces by the oral engagement members of the mouthpiece; transmit, based on the calculated pressure being within a pressure threshold range, a start operation signal; and transmit, based on the calculated pressure being outside the pressure threshold range, a stop operation signal to the mouthpiece to inhibit or prevent operation of the mouthpiece.

In Example 15, the subject matter of any one or more of Examples 13-14 optionally include wherein the control system comprises: a controller including processing circuitry; and memory coupled to the controller, the memory including instructions that, when performed by the processing circuitry, are configured to cause the controller to: determine, based on the pressure signal, a calculated pressure exerted on the oral engagement members of the mouthpiece by the oral surfaces of the user; transmit, based on the calculated pressure being beyond a threshold, a stop operation signal.

In Example 16, the subject matter of any one or more of Examples 1-15 optionally include wherein the mouthpiece comprises a track carrying the oral engagement members, the track configured to removably attach the oral engagement members to the mouthpiece.

In Example 17, the subject matter of any one or more of Examples 1-16 optionally include wherein the mouthpiece comprises: a first track portion including a first portion of the oral engagement members; and a second track portion including a second portion of the oral engagement members, and wherein the first track portion and the second track portion are configured to removably couple the first portion of the oral engagement members and the second portion of the oral engagement members to the mouthpiece, respectively.

In Example 18, the subject matter of Example 17 optionally includes wherein the first portion of the oral engagement members comprises a plurality of groupings of oral engagement members, and wherein each bristle of the plurality of groupings of oral engagement members has a similar stiffness.

In Example 19, the subject matter of any one or more of Examples 1-18 optionally include wherein the mouthpiece includes a semi-arcuate profile.

In Example 20, the subject matter of any one or more of Examples 1-19 optionally include wherein the mouthpiece includes a U-shaped profile.

Example 21 includes a method, device, system, or apparatus including any element of any of Example 1-20.

The above-detailed description includes references to the accompanying drawings, which form a part of the detailed description. The drawings show, by way of illustration, specific examples that may be practiced. These embodiments are also referred to herein as “examples. ” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more. ” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein. ” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The term “about,” as used herein, means approximately, in the region of, roughly, or around. When the term “about” is used in conjunction with a numerical range, it modifies that range by extending the boundaries above and below the numerical values set forth. In general, the term “about” is used herein to modify a numerical value above and below the stated value by a variance of 10%. In one aspect, the term “about” means plus or minus 10% of the numerical value of the number with which it is being used. Therefore, about 50% means in the range of 45%-55%. Numerical ranges recited herein by endpoints include all numbers and fractions subsumed within that range (e.g., 1 to 5 includes 1, 1.5, 2, 2.75, 3, 3.90, 4, 4.24, and 5). Similarly, numerical ranges recited herein by endpoints include subranges subsumed within that range (e.g., 1 to 5 includes 1-1.5, 1.5-2, 2-2.75, 2.75-3, 3-3.90, 3.90-4, 4-4.24, 4.24-5, 2-5, 3-5, 1-4, and 2-4). It is also to be understood that all numbers and fractions thereof are presumed to be modified by the term “about.” The above description is intended to be illustrative, and not restrictive. For example, the above-described examples (or one or more aspects thereof) may be used in combination with each other. Other examples may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the examples should be determined with reference to the appended claims, along with the full scope of equivalents to which such claims are entitled.

What is claimed is:

1. An oral care device comprising:
a mouthpiece configured for at least partial insertion into a mouth of a user, the mouthpiece having an arcuate shape to cover a tooth of the user, the mouthpiece including:
oral engagement members removably installed into the mouthpiece and configured to contact oral surfaces; and
a sensor integrated within the mouthpiece, the sensor configured to detect an operational characteristic of the mouthpiece during use by the user;
a base configured to receive the mouthpiece and charge and clean the mouthpiece upon connection with the mouthpiece; and
a control system configured to control operation of the oral care device based on at least the operational characteristic of the mouthpiece.

2. The oral care device of claim 1, wherein the mouthpiece comprises:
a first energy device configured to translate the oral engagement members along a first axis; and
a second energy device configured to generate a vibrational frequency and propagate the vibrational frequency to the oral engagement members.

3. The oral care device of claim 2, wherein the first axis is configured to align with a long axis of the tooth of the user.

4. The oral care device of claim 2, wherein the oral engagement members are configured to conform to one or more oral surfaces that include one or more of a facial, occlusal, proximal, incisal, or lingual surfaces of the tooth, gums, or a tongue of the user.

5. The oral care device of claim 4, wherein the vibrational frequency is configured to stimulate the oral surfaces to clean the oral surfaces.

6. The oral care device of claim 1, wherein the mouthpiece comprises:
a fluid tank configured to store a fluid within the mouthpiece; and
a spray port configured to direct the fluid toward the oral surfaces of the user.

7. The oral care device of claim 6, wherein the fluid comprises at least one of a toothpaste, a mouthwash, or a medicated solution.

8. The oral care device of claim 7, wherein the base comprises a reservoir to store fluid, and wherein the base is configured to refill the fluid tank of the mouthpiece when the mouthpiece is installed on the base.

9. The oral care device of claim 1, wherein the sensor includes an accelerometer, and wherein the accelerometer is configured to generate a movement signal indicative of sudden movement of the mouthpiece.

10. The oral care device of claim 9, wherein the control system comprises:
a controller including processing circuitry; and
memory coupled to the controller, the memory including instructions that, when performed by the processing circuitry, are configured to cause the controller to:
determine, based on the movement signal, a magnitude of movement of the mouthpiece;
transmit, based on the magnitude of movement of the mouthpiece being beyond a movement threshold range, a stop operation signal to the mouthpiece to inhibit or prevent operation of the mouthpiece; and
transmit, based on the magnitude of movement being within the movement threshold range, a start operation signal to the mouthpiece to start brushing operations.

11. The oral care device of claim 1, wherein the sensor includes a position sensor, and wherein the position sensor is configured to generate a position signal indicative of an orientation of the mouthpiece.

12. The oral care device of claim 11, wherein the control system comprises:
a controller including processing circuitry; and
memory coupled to the controller, the memory including instructions that, when performed by the processing circuitry, are configured to cause the controller to:
determine, based on the position signal, a calculated orientation of the mouthpiece;
transmit, based on the calculated orientation of the mouthpiece being beyond an orientation threshold range, a stop operation signal to the mouthpiece to inhibit or prevent operation of the mouthpiece; and
transmit, based on the calculated orientation being within the orientation threshold range, a start operation signal to the mouthpiece to start brushing operations upon proper insertion of the mouthpiece onto the oral surfaces and specified positioning of the user.

13. The oral care device of claim 1, wherein the sensor includes a pressure sensor, and wherein the pressure sensor is configured to generate a pressure signal indicative of a pressure exerted on the oral engagement members or the mouthpiece by the oral surfaces.

14. The oral care device of claim 13, wherein the control system comprises:
a controller including processing circuitry; and
memory coupled to the controller, the memory including instructions that, when performed by the processing circuitry, are configured to cause the controller to:
determine, based on the pressure signal, a calculated pressure exerted on the oral surfaces by the oral engagement members of the mouthpiece;
transmit, based on the calculated pressure being within a pressure threshold range, a start operation signal; and
transmit, based on the calculated pressure being outside the pressure threshold range, a stop operation signal to the mouthpiece to inhibit or prevent operation of the mouthpiece.

15. The oral care device of claim 13, wherein the control system comprises:
a controller including processing circuitry; and
memory coupled to the controller, the memory including instructions that, when performed by the processing circuitry, are configured to cause the controller to:
determine, based on the pressure signal, a calculated pressure exerted on the oral engagement members of the mouthpiece by the oral surfaces of the user; and
transmit, based on the calculated pressure being beyond a threshold, a stop operation signal.

16. The oral care device of claim 1, wherein the mouthpiece comprises a track carrying the oral engagement members, the track configured to removably attach the oral engagement members to the mouthpiece.

17. The oral care device of claim 1, wherein the mouthpiece comprises:
a first track portion including a first portion of the oral engagement members; and
a second track portion including a second portion of the oral engagement members, and wherein the first track portion and the second track portion are configured to removably couple the first portion of the oral engagement members and the second portion of the oral engagement members to the mouthpiece, respectively.

18. The oral care device of claim 17, wherein the first portion of the oral engagement members comprises a plurality of groupings of oral engagement members, and wherein each bristle of the plurality of groupings of oral engagement members has a similar stiffness.

19. The oral care device of claim 1, wherein the mouthpiece includes a J-shaped profile.

20. The oral care device of claim 1, wherein the mouthpiece includes a U-shaped profile.
